(19) United States
(12) Patent Application Publication
(10) Pub. No.: US 2016/0132356 A1
(43) Pub. Date: May 12, 2016

(54) MANAGEMENT APPARATUS AND METHOD FOR SYSTEM CONFIGURATION

(71) Applicant: FUJITSU LIMITED, Kawasaki-shi (JP)

(72) Inventors: Makoto Kozawa, Yokohama (JP); Masashi Agata, Kawasaki (JP)

(73) Assignee: FUJITSU LIMITED, Kawasaki-shi (JP)

(21) Appl. No.: 14/988,184

(22) Filed: Jan. 5, 2016

Related U.S. Application Data
(63) Continuation of application No. PCT/JP2013/069056, filed on Jul. 11, 2013.

(51) Int. Cl. G06F 9/50

(52) U.S. Cl. CPC G06F 9/50

(57) ABSTRACT

A management apparatus includes (A) an acceptance unit to accept an instruction to dynamically change a processor configuration in a system that includes plural processors, and (B) a processing unit to identify a performance value of a system corresponding to a processor configuration caused by instructed dynamic change, determine whether or not the identified performance value is equal to or greater than a requested performance value for the system, and perform a processing to change the processor configuration instructed by the accepted instruction, upon determining that the identified performance value is equal to or greater than the requested performance value.

### CROSS-REFERENCE TO RELATED APPLICATIONS

This application is a continuing application, filed under 35 U.S.C. section 111(a), of International Application PCT/JP2013/069056, filed on Jul. 11, 2013, the entire contents of which are incorporated herein by reference.

### FIELD

This invention relates to a technique for dynamically changing a system configuration.

### BACKGROUND

Dynamic Partitioning (hereinafter, called “DP”) is a technique (also called “hot swapping”) for taking out and putting in a Central Processing Unit (CPU. also called “processor”), memory or the like while a system is operating.

Typically, when an opportunity of a DP operation such as a failure of the CPU or memory in a system is detected, an administrator of the system performs a DP operation for the CPU or memory. However, when the CPU is extracted and inserted during the operation of the system, an influence to the system by extracting and inserting the CPU has to be considered, and there is a case where it is inappropriate that the DP operation is performed in response to the detected opportunity.

In addition, for example, as a technique for dynamically reconfiguring resources, there is a technique for performing a proposed operation after determining whether or not the proposed operation of the reconfiguration follows a policy of the resource allocation. However, the DP operation for the CPU is not deeply considered.

Patent Document 1: Japanese Laid-open Patent Publication No. 7-295841

### SUMMARY

Therefore, there is no conventional technique for enabling confirmation of whether or not the DP operation is appropriate.

A management apparatus relating to this invention includes an acceptance unit to accept an instruction to dynamically change a processor configuration in a system that includes plural processors, and (B) a processing unit to identify a performance value of a system corresponding to a processor configuration caused by instructed dynamic change, determine whether or not the identified performance value is equal to or greater than a requested performance value for the system, and perform a processing to change the processor configuration instructed by the accepted instruction, upon determining that the identified performance value is equal to or greater than the requested performance value.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram of an entire system configuration relating to an embodiment;

FIG. 2 is a functional block diagram of a management apparatus relating to the embodiment;

FIG. 3 is a diagram schematically illustrating changes of CPU topology;

FIG. 4 is a diagram depicting examples of performance values corresponding to the CPU topology;

FIG. 5 is a diagram depicting an example of load prediction data;

FIG. 6 is a diagram depicting an example of data stored in a system load prediction data storage unit;

FIG. 7 is a diagram depicting a processing flow of processing relating to the embodiment;

FIG. 8A is a diagram depicting a processing flow of precheck processing relating to the embodiment;

FIG. 8B is a diagram depicting a processing flow of the precheck processing relating to the embodiment;

FIG. 9 is a diagram depicting another system configuration example;

FIG. 10 is a functional block diagram of a computer; and

FIG. 11 is a functional block diagram of a computer.

### DESCRIPTION OF EMBODIMENTS

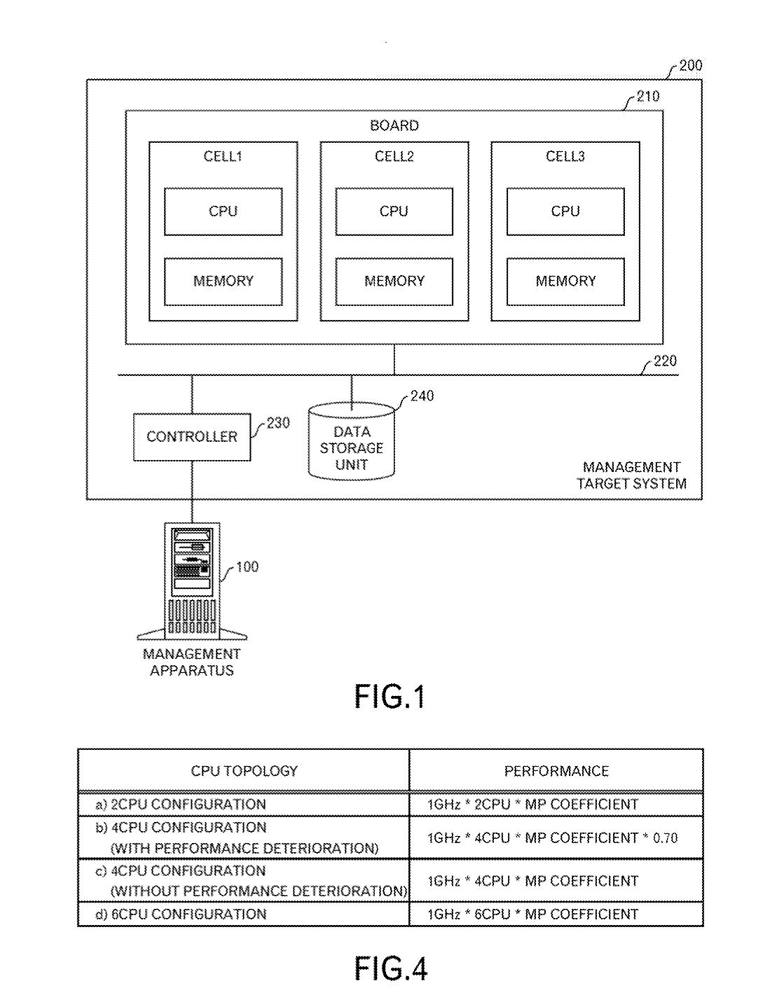

FIG. 1 illustrates an entire system relating to this embodiment. In this embodiment, a management target system 200 and a management apparatus 100 that manages DP operations for the management target system 200 are connected with a network. The management target system 200 relating to this embodiment has a board 210 on which plural cells that respectively include a CPU and a memory and the hot swapping is possible (in FIG. 1, there are three cells, however, the number of cells is not limited to three.). Furthermore, in the management target system 200, the board 210, a controller 230 that monitors and controls the cells on the board 210 and a data storage unit 240 that stores results of the monitoring or controlling by the controller 230 are connected through a bus 220.

Data of errors or the like that occurred in the cell on the board 210 is stored in the data storage unit 240 as error logs. Moreover, assume that the controller 230 can obtain load data of the CPU (e.g. CPU utilization rate, memory utilization amount and/or the like) on the board 210. Furthermore, the controller 230 outputs data (also called “error data”) of the error logs and/or load data to the management apparatus 100 in response to a request from the management apparatus 100 or the like. The management target system 200 is the same as the conventional one.

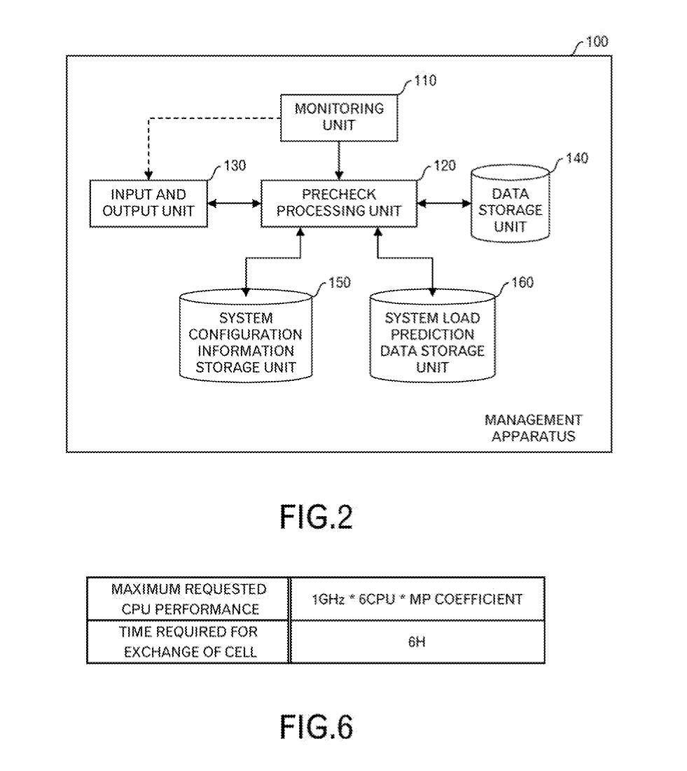

FIG. 2 illustrates a functional block diagram of the management apparatus 100. The management apparatus 100 has a monitoring unit 110, a precheck processing unit 120, an input and output unit 130, a data storage unit 140, a system configuration information storage unit 150 and a system load prediction data storage unit 160.

The monitoring unit 110 obtains the load data and error data from the management target system 200 periodically, or at arbitrary timings. The input and output unit 130 accepts inputs from the administrator of the management target system 200, and outputs an alarm, precheck result and the like. The data storage unit 140 stores data in the process of processing. The precheck processing unit 120 performs processing to determine in advance whether or not the DP operation should be performed.

The system configuration information storage unit 150 stores system configuration information such as data of a memory configuration on the board 210 in the management target system 200 and/or CPU topology data.

Data of the memory configuration is data that represents the application status of a memory RAS (Reliability Availability and Serviceability) function (e.g. memory mirroring, memory sparing, memory error reporting and the like).

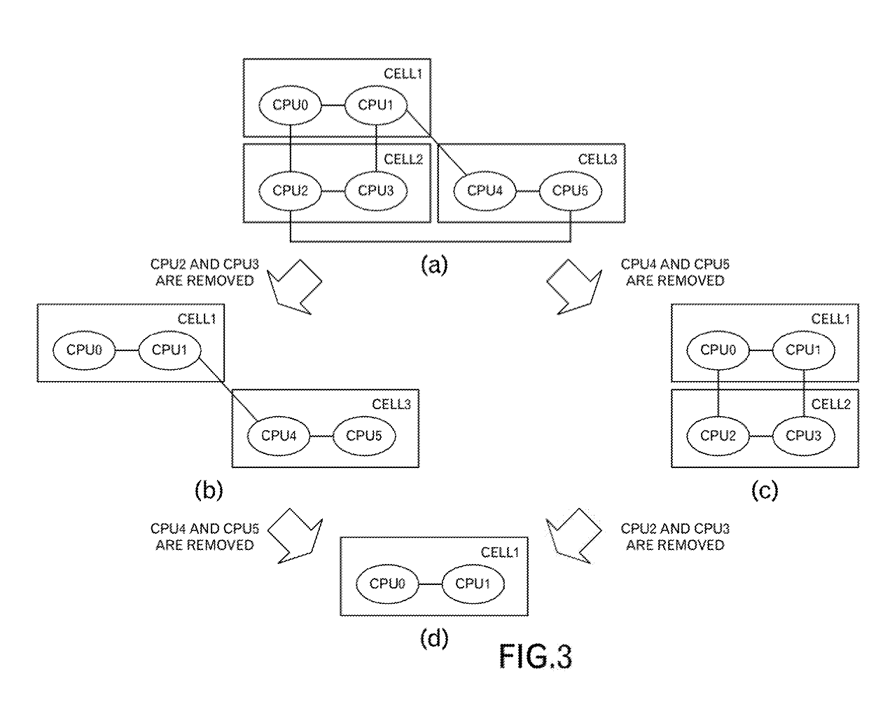

In addition, CPU topology data is data of performance values for respective CPU topology. An example where two CPUs are included in each of three cells will be explained. In other words, CPU0 and CPU1 are included in cell 1, CPU2 and CPU3 are included in cell 2, and CPU4 and CPU5 are included in cell 3. As illustrated in (a) of FIG. 3, in the configuration of three cells and 6 CPUs, CPUs are connected in each cell, and furthermore, CPU4 and CPU1 are connected each other, CPU0 and CPU2 are connected each other, CPU2 and CPU5 are connected each other, and CPU1 and CPU3 are connected each other. In the state of (a) of FIG. 3, when the cell 2 (CPU2 and CPU3) is removed, a state of (b) of FIG. 3 is obtained. In other words, when the cell 2 is removed, the connection between the cell 1 and the cell 3 is only the connection between CPU1 and CPU4, and when CPU0 communicates with CPU5, CPU1 and CPU4 have to be passed through. Therefore, performance deterioration occurs. In the state of (a) of FIG. 3, also when the cell 1 is removed, the performance deterioration occurs as illustrated in (b) of FIG. 3. On the other hand, in the state of (a) of FIG. 3, when the cell 3 (CPU4 and CPU5) is removed, a state of (c) of FIG. 3 is obtained. Even when the cell 3 is removed, CPU0 and CPU2 are connected each other and CPU1 and CPU3 are connected each other between the cells 1 and 2. Therefore, for example, when the CPU2 and CPU1 communicate each other, the communication can be performed by passing only through CPU0 or CPU3. Accordingly, the performance deterioration does not occur. When the cell 3 is removed from the state of (b) of FIG. 3 or the cell 2 is removed from the state of (c) of FIG. 3, a state of (d) of FIG. 3, in other words, a state where only the cell 1 exists is obtained.

In case of such CPU topology, data as illustrated in FIG. 4 is stored in the system configuration information storage unit 150. In an example of FIG. 4, for each pattern of CPU topology (e.g. cell configuration pattern (e.g. cells 1 and 2 or the like)), a performance value is stored. In the example of FIG. 3, the performance does not change when any of cells is selected in the configuration of 2 CPUs in one cell and the configuration of 6 CPUs in three cells. However, as illustrated in (b) and (c) of FIG. 3, in the configuration of 4 CPUs in two cells, the performance deteriorates or does not deteriorate depending on the cell to be removed. Therefore, specifically, when the cell is removed, the CPU topology is different depending on which cell is removed, and whether or not the performance deterioration occurs is also different. Therefore, the cases are distinguished. An MP coefficient represents an improvement ratio of the performance in case where the number of CPUs is increased in a Symmetric Multiple Processor (SMP) system when the system is designed. For example, when the MP coefficient is 1.8, a machine in which two CPUs are equipped has 1.8-fold performance of a machine in which one CPU is equipped. Then, in the example of FIG. 4, in case of 4-CPU configuration, an example of the performance deterioration ratio=0.7 is depicted. However, this varies depending on the system. In addition, the performance is represented on the conversion into a CPU whose drive frequency is 1 GHz. However, this is a mere example.

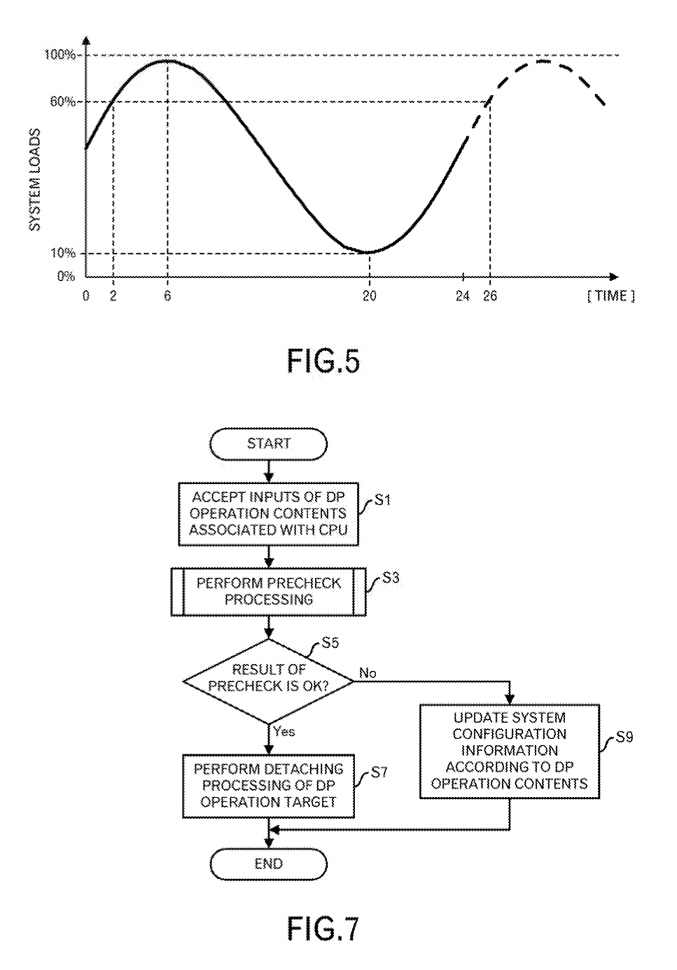

In addition, the system load prediction data storage unit 160 stores load prediction data of the management target system 200. The load prediction data is data as illustrated in FIG. 5, for example.

In an example of FIG. 5, a temporal change of the system load is represented. Specifically, the load becomes 10%, which is the minimum, at about 20 o'clock, and gradually increases. Then, the load becomes about 100%, which is the maximum, at about 6 o'clock, and then decreases after that. Because of such a temporal change, when the DP operation requires a time, the load changes until the DP operation is completed.

The system load prediction data storage unit 160 also stores data as illustrated in FIG. 6. As illustrated in FIG. 6, the maximum requested CPU performance and a time required for exchange of the cell are stored. The system load (%) illustrated in FIG. 5 is represented as a ratio to the maximum requested CPU performance. In addition, the time required for exchange of the cell is a time required until a component to be replaced is obtained and the component to be replaced is actually installed on the board 210 of the management target system 200. Such data is also different depending on the management target system 200.

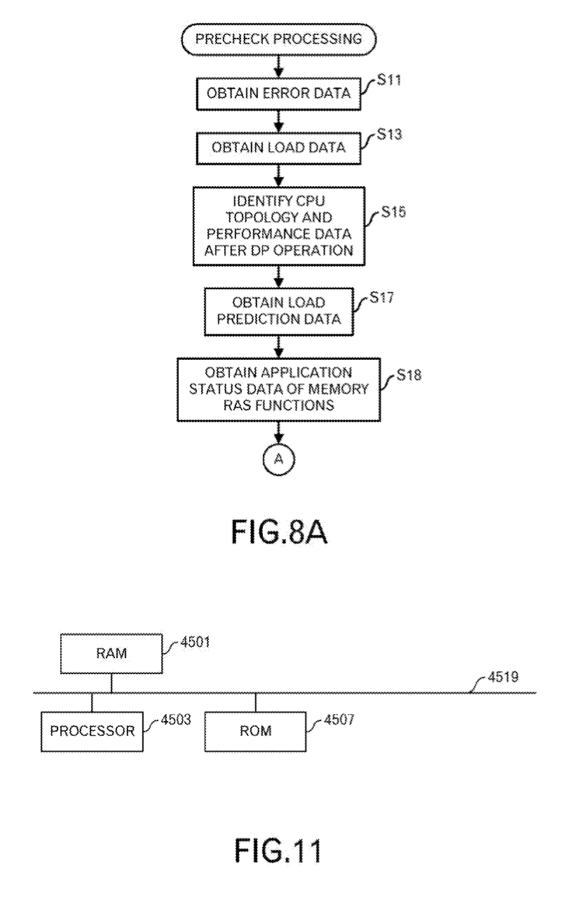

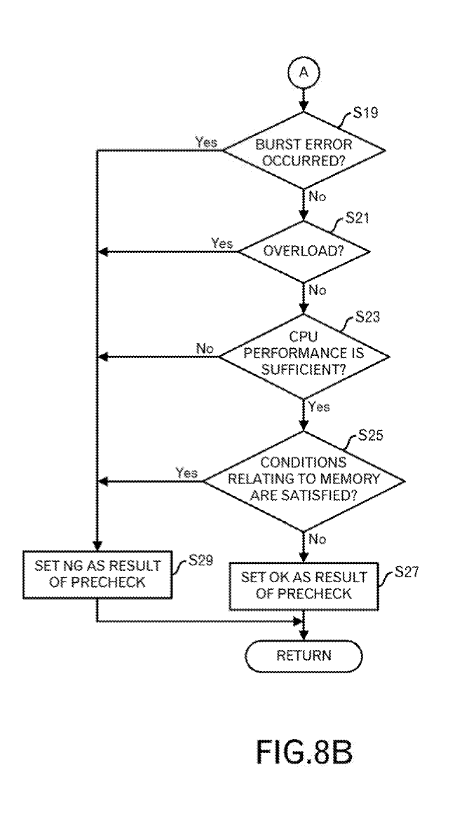

Next, operations of the management apparatus 100 will be explained by using FIGS. 7 to 8B. Firstly, assume that information of details on the DP operation are inputted through the input and output unit 130 by an administrator, after the monitoring unit 110 of the management apparatus 100 detects a trigger of the DP operation based on the error data or load data, which is obtained from the management target system 200, and notifies the administrator, for example, through the input and output unit 130.

For example, the notification to the administrator is performed when a series of correctable errors are detected in the CPU or memory, when a sign of the performance shortage is detected, in other words, in a case where the system load exceeds the threshold, or when any failure that occurred in the cell is detected. The administrator performs the DP operation in order to exchange the cell in which the error was detected or to add a cell in order to avoid the performance shortage. However, in order to confirm whether or not the DP operation can be actually performed, the management apparatus 100 is caused to execute the following processing before the DP operation is actually performed.

Typically, in many case, administrators do not have sufficient knowledge for the CPU topology as illustrated in FIG. 3, and do not have any understanding that the performance deterioration occurs in the cell configuration as illustrated in (b) of FIG. 3. In addition, the administrator may not grasp the status of the error occurrences, the status of the loads, the setting status of the memory RAS functions. Therefore, by executing the processing relating to this embodiment, it is automatically checked whether or not the DP operation can be performed at this timing.

Firstly, the input and output unit 130 accepts inputs of information of details on the DP operation, which are associated with the CPU, and outputs the input data to the precheck processing unit 120 (FIG. 7: step S1). For example, the input of a number of a cell to be exchanged is accepted.

Then, the precheck processing unit 120 performs precheck processing (step S3). The precheck processing will be explained by using FIGS. 8A and 8B.

Firstly, the precheck processing unit 120 obtains error data for a predetermined time period, which is stored in the data storage unit 240 of the management target system 200, through the monitoring unit 110 and the controller 230 of the management target system 200, and stores the obtained error data in the data storage unit 140 (FIG. 8A: step S11).

Moreover, the precheck processing unit 120 obtains load data from the controller 230 through the monitoring unit 110, and stores the obtained load data in the data storage unit 140 (step S13).

Then, the precheck processing unit 120 identifies CPU topology and performance data, which are caused by the DP operation, based on the number of the cell to be removed by the DP operation, by using data for the CPU topology, which is stored in the system configuration information storage unit 150 (step S15). For example, when the current CPU topology (i.e. cell configuration) corresponds to the state of (a) of FIG. 3 and one cell is removed, it is identified, based on the number of the cell to be removed, which of the states illustrated in (b) and (c) of FIG. 3 is obtained after the DP operation. Moreover, when two cells are removed, it is identified that the state of (d) in FIG. 3 is obtained. When the current CPU topology is as illustrated in (b) or (c) of FIG. 3, it is identified, based on the number of the cell to be removed by the DP operation, that the state of (d) in FIG. 3 is obtained after the DP operation. Furthermore, the performance data corresponding to the CPU topology after the identified DP operation is identified according to association data between the CPU topology and the performance, which is illustrated in FIG. 4.

Furthermore, the precheck processing unit 120 reads out the load prediction data from the system load prediction data storage unit 160 (step S17). Data that represents the temporal change of the system load as illustrated in FIG. 5 and data as illustrated in FIG. 6 are read out.

In addition, the precheck processing unit 120 reads out application status data of the memory RAS functions from the system configuration information storage unit 150 (step S18).

The steps S11 to S18 are preprocessing, and the step S11 may be executed immediately before the step S19, and the step S13 may be executed immediately before the step S21, and the step S15 may be executed immediately before the step S23, and the step S18 may be executed immediately before the step S25.

The processing shifts to processing of FIG. 8B through terminal A, and the precheck processing unit 120 determines, based on the obtained error data, whether or not a burst error occurred (step S19). The burst error represents a state in which errors frequently occur, for example, the number of errors exceeds a predetermined level within a predetermined time (e.g. some errors or more occur within one minute.). When the DP operation is performed in such a state, the operations of the entire system may stop. Therefore, it is dangerous to perform the DP operation.

When the burst error occurred, it is inappropriate to perform the DP operation, the precheck processing unit 120 sets NG (i.e. impossible to perform the DP operation) as a precheck result (step S29). Then, the processing returns to a calling-source processing.

On the other hand, when the burst errors do not occur, the precheck processing unit 120 determines, based on the obtained load data, whether or not the management target system 200 is in an overload state (step S21). It is determined whether or not the current load (e.g. CPU utilization ratio, memory utilization rate and the like) exceeds a threshold (e.g. 90%). This is because the performance deterioration occurs when the DP operation is performed in the overload state, and an impact on the entire system may become large. Also in this step, it may be confirmed, based on the system load prediction data as illustrated in FIG. 5, whether or not the system load exceeds a predetermined level until the time required for the cell exchange elapsed since the present time (FIG. 6).

When the management target system 200 is in the overload state, the processing shifts to step S29. On the other hand, when the management target system 200 is not in the overload state, the precheck processing unit 120 determines whether or not the CPU performance after removing the cell by the DP operation is sufficient within the period of the DP operation (step S23).

For example, a case is considered that the DP operation that makes the transition from (a) of FIG. 3 to (b) of FIG. 3, in other words, the DP operation to exchange the cell 2 that includes CPU2 and CPU3 is performed at 20 o'clock. In addition, assume that the time required for the cell exchange is 6 hours (FIG. 6), and the maximum requested CPU performance is “1 GHz*6 CPU*MP coefficient” (FIG. 6).

Here, when the system load prediction is as illustrated in FIG. 5, it can be understood that a peak of the load within 6 hours since 20 o'clock is 60% at 2 o'clock. Then, the load request for the maximum requested CPU performance (1 GHz*6 CPU*MP coefficient)*60% (=3.6 GHz*1 CPU*MP coefficient) occurs during the period of the DP operation.

On the other hand, the performance that was identified at the step S15 and corresponds to the CPU topology is (1 GHz*4 CPU*MP coefficient)*0.7 (=2.8 GHz*1 CPU*MP coefficient), because this CPU topology corresponds to a pattern in which the performance deterioration occurs.

Then, when the CPU performance after the cell is removed by the DP operation is compared with the load request during the period of the DP operation, the latter is larger. Therefore, a state in which the performance is insufficient for the load request is obtained during the period of the DP operation. Therefore, the performance of the DP operation at this timing is a problem, and the DP operation is staved off.

On the other hand, when the CPU performance after the cell is removed by the DP operation is equal to or greater than the load request during the period of the DP operation, the DP operation can be performed without any problem.

When the CPU performance after the cell is removed by the DP operation is not sufficient during the period of the DP operation, the processing shifts to step S29. On the other hand, when the CPU performance after the DP operation is sufficient during the period of the DP operation, the precheck processing unit 120 determines whether or not a condition relating to the memory is satisfied (step S25). More specifically, it is determined, based on the data obtained at the step S18, whether or not any memory RAS function is applied, and it is determined, based on the data obtained at the step S11, whether or not a condition that an error occurs within a predetermined time in a memory to which the memory RAS function is applied is satisfied.

In a certain management target system, the memory RAS function is invalidated during the DP operation. When the DP operation is performed in such a system, the system down may occur when the memory error or the like occurs during the DP operation. Supposing that the DP operation is not performed, the operation of the system may continue by recovering the error by the memory RAS function such as memory sparing. Therefore, when the error occurs within the predetermined time in the memory to which the memory RAS function is applied, the DP operation is staved off in order to avoid such a danger. When any memory RAS function is supported and the cell includes the memory, this condition is considered. However, the step S25 may not be performed when a system in which the memory RAS function is not supported or when the cell does not include the memory.

Therefore, when such a condition is satisfied, the processing shifts to the step S29. On the other hand, when such a condition is not satisfied, the precheck processing unit 120 sets OK as the precheck result (step S27). Then, the processing returns to the calling-source processing.

In this embodiment, whether or not the DP operation can be performed is determined based on the burst error, overload, CPU performance and the memory condition, however, more conditions may be used.

Returning to the explanation of the processing in FIG. 7, the precheck processing unit 120 determines whether or not the precheck result is OK (step S5). When the precheck result is OK, the precheck processing unit 120 causes the controller 230 of the management target system 200 through the monitoring unit 110 to perform processing to detach the cell for which the DP operation is performed (step S7). This processing itself is the same as the conventional one, and is a processing that should be performed by the administrator before the cell is actually picked up. Other processing may be included. When the precheck processing unit 120 receives notification of the detachment completion from the controller 230 of the management target system 200 through the monitoring unit 110, the precheck processing unit 120 may notify the administrator of a message that represents the DP operation is possible through the input and output unit 130.

On the other hand, when the precheck result is NG, the precheck processing unit 120 updates the system configuration information in the system configuration information storage unit 150 according to information of details on the DP operation (step S9). When the reactivation of the management target system 200 is performed next time, the reactivation is performed based on the system configuration after the DP operation. The updated system configuration information may be stored in the data storage unit 240 of the management target system 200 or the like through the monitoring unit 110 and the controller 230.

The precheck processing unit 120 causes the input and output unit 130 to output a message that represents that the DP operation is impossible. By doing so, the administrator can recognize that the DP operation cannot be performed at the present timing.

According to this embodiment, it becomes possible to automatically determine, in advance, whether or not the DP operation can be performed. By doing so, after confirming that the DP operation can be performed while suppressing the influence on the entire management target system 200, the actual DP operation is performed. In addition, when the present time is an inappropriate timing, that DP operation is staved off.

Although the embodiments of this invention were explained above, this invention is not limited to those. For example, the functional block diagram illustrated in FIG. 2 is a mere example, and may not correspond to a program module configuration. In addition, as for the processing flows, as long as the processing results do not change, turns of the steps may be exchanged or plural steps may be executed in parallel. For example, the turns of the steps in FIG. 8B may be exchanged, and may be executed in parallel.

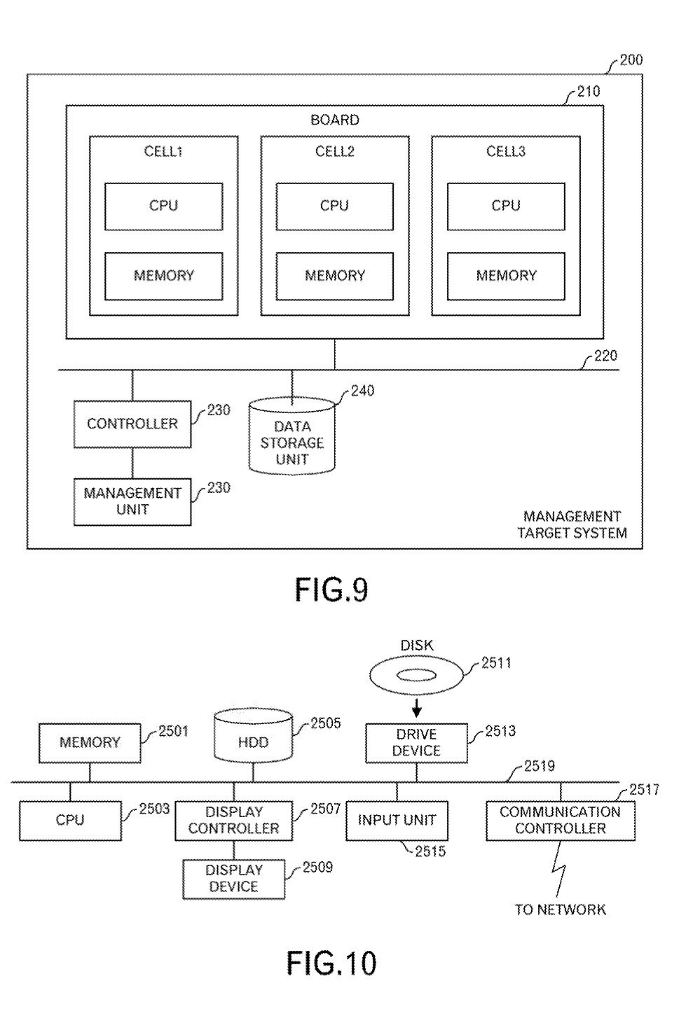

Furthermore, the example of FIG. 1 illustrates an example that the management targets system 200 and the management apparatus 100 are connected through a network. However, as illustrated in FIG. 9, a configuration may be employed that a management unit 260 that has functions of the management apparatus 100 is included in the management target system 200. According to circumstances, the controller 230 and the management unit 260 may be integrated.

Furthermore, the functions of the management apparatus 100 may be shared by plural computers.

In addition, the aforementioned management apparatus 100 is a computer device as depicted in FIG. 10. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as depicted in FIG. 10. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

In addition, as illustrated in FIG. 9, when the management unit 260 is provided within the management target system 200, the management unit 260 itself is a computer device, and as illustrated in FIG. 11, a Random Access Memory (RAM) 4501, a processor 4503 and a Read-Only memory (ROM) 4507 are connected via a bus 4519. A control program to perform a processing in this embodiment and an Operating System (OS), if it exists, are stored in the ROM 4507 and when they are executed by the processor 4503, they are read out from the ROM 4507 to the RAM 4501. In addition, data in the process of the processing is stored in the RAM 4501. The processor 4503 may include the ROM 4507, and furthermore, may include the RAM 4501. In the embodiments of the invention, the control program to perform the aforementioned processing may be distributed by a computer-readable removable disk that stores the control program, and may be written by a ROM writer into the ROM 4507. Such a computer device realizes the aforementioned respective functions by effectively cooperating the hardware such as the processor 4503, RAM 4501 and the ROM 4507 with the control program (according to circumstances, also OS).

The aforementioned embodiments are outlined as follows:

A management method relating to the embodiments includes (A) upon accepting an instruction to dynamically change a processor configuration in a system that includes plural processors, identifying a performance value of a system corresponding to a processor configuration caused by instructed dynamic change; (B) determining whether the identified performance value is equal to or greater than a requested performance value for the system; and (C) upon determining that the identified performance value is equal to or greater than the requested performance value, performing a processing to change the processor configuration instructed by the instruction.

Because the level of the performance deterioration caused by the dynamic change of the processor configuration may be different, it becomes possible to determine, in advance, whether or not the dynamic change of the processor configuration is suitable, by determining, based on the performance value of the system corresponding to the processor configuration caused by the dynamic change, whether or not the performance value is equal to or greater than the requested performance value.

The aforementioned requested performance value may be calculated according to loads in the system. The performance deterioration caused by the dynamic change of the processor configuration may be acceptable depending on the load of the system.

Furthermore, the aforementioned requested performance value may be calculated according to loads of the system within a predetermined time since the present time. This calculation is performed to cope with a case that the system load increases during the dynamic change of the processor configuration.

Furthermore, the aforementioned requested performance value may be calculated according to a peak of the loads of the system within a predetermined time required for the instructed dynamic change since the present time. This is because there is no problem if the peak of the load of the system can be processed.

Furthermore, the aforementioned management method may further include determining whether at least one of a first condition that errors occurred in the system at a frequency that is equal to or greater than a first predetermined level, a second condition that a load in the system is equal to or greater than a second predetermined level and a third condition that an error occurred in a memory of the system, to which a memory Reliability Availability and Serviceability (RAS) function is applied is satisfied. This is because there are not only the performance value of the processor, but also other items whose influence on the entire system is to be considered.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory such as ROM (Read Only Memory), and hard disk. In addition, the intermediate processing result is temporarily stored in a storage device such as a RAM or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A management apparatus, comprising:
a memory; and
a microprocessor configured to use the memory and execute a process, the process comprising:
accepting an instruction to dynamically change a processor configuration in a system that includes a plurality of processors;
identifying a performance value of a system corresponding to a processor configuration caused by instructed dynamic change;
determining whether the identified performance value is equal to or greater than a requested performance value for the system; and
upon determining that the identified performance value is equal to or greater than the requested performance value, performing a processing to change the processor configuration instructed by the instruction.

2. The management apparatus as set forth in claim 1, wherein the requested performance value is calculated according to a load in the system.

3. The management apparatus as set forth in claim 1, wherein the requested performance value is calculated according to loads of the system within a predetermined time since a present time.

4. The management apparatus as set forth in claim 1, wherein the request performance value is calculated according to a peak of loads of the system in a predetermined time required for the instructed dynamic change since a present time.

5. The management apparatus as set forth in claim 1, wherein the process further comprises:
determining whether at least one of a first condition that errors occurred in the system at a frequency that is equal to or greater than a first predetermined level, a second condition that a load in the system is equal to or greater than a second predetermined level and a third condition that an error occurred in a memory of the system, for which a memory Reliability Availability and Serviceability function is applied is satisfied.

6. A non-transitory, computer-readable storage medium storing a program for causing a computer to execute a process, the process comprising:
upon accepting an instruction to dynamically change a processor configuration in a system that includes a plurality of processors, identifying a performance value of a system corresponding to a processor configuration caused by instructed dynamic change;
determining whether the identified performance value is equal to or greater than a requested performance value for the system; and
upon determining that the identified performance value is equal to or greater than the requested performance value, performing a processing to change the processor configuration instructed by the instruction.

7. A management method, comprising:
upon accepting an instruction to dynamically change a processor configuration in a system that includes a plurality of processors, identifying, by using a computer, a performance value of a system corresponding to a processor configuration caused by instructed dynamic change;
determining whether the identified performance value is equal to or greater than a requested performance value for the system; and
upon determining that the identified performance value is equal to or greater than the requested performance value, performing a processing to change the processor configuration instructed by the instruction.
